(19) United States
(12) Patent Application Publication
(10) Pub. No.: US 2014/0195216 A1
(43) Pub. Date: Jul. 10, 2014

(54) COMPUTATIONAL DESIGN OF IDEOTYPICALLY MODULATED PHARMACOEFFECTORS FOR SELECTIVE CELL TREATMENT

(71) Applicant: IMPERIUM BIOTECHNOLOGIES, INC., Coppell, TX (US)

(72) Inventor: Jacob Jennings Orme, Coppell, TX (US)

(73) Assignee: Imperium Biotechnologies, Inc., Coppell, TX (US)

(21) Appl. No.: 13/736,797

(22) Filed: Jan. 8, 2013

(51) Int. Cl. G06F 19/12

(52) U.S. Cl. CPC G06F 19/12
USPC 703/11

(57) ABSTRACT

In system and method embodiments, an embodiment includes the collection, input, and organization of target nucleotide source or sources; the identification of potential target sequences for ideotypically modulated pharmacoeffectors (IMP); the exclusion, prioritization, or deprioritization of target sequences on the basis of undesirable binding for ideotypically modulated pharmacoeffectors (IMP); and/or the design of targeting sequences on the basis of reverse complementarity or sequence complementarity. IMPs are designed for optimal use in respective applications, including cancers, autoimmune diseases, infectious diseases, cellular diseases, and other applications.

### TECHNICAL FIELD

This invention relates generally to ideotype-specific treatments of cells and organisms, and more particularly to ideotype-specific treatments of cells and organisms using engineered Ideotypically Modulated Pharmacoeffectors (IMPs).

### BACKGROUND

In the human body, each cell type expresses a unique assortment of proteins, lipids, sugars, nucleotide sequences, and other metabolites. Each of these is a potential antigen, having epitopes with which a molecule having predetermined affinity can interact. The expression of said antigens is modified by the status of the cell and by its environment. This expression becomes further modified when viruses or intracellular bacteria introduce foreign materials into the cell as they infect. Viruses in particular hijack the cell machinery and produce many virion copies that bud off from the cell and infect other cells.

### SUMMARY

A method and system are provided for the design of maximally effective ideotypically modulated pharmacoeffectors (IMPs). IMP design is a non-trivial process including multiple steps that may enhance the final product for use in medical or research applications. These steps may include the collection, input, and organization of target nucleotide source or sources; the identification of potential target sequences for ideotypically modulated pharmacoeffectors (IMP); the exclusion, prioritization, or deprioritization of target sequences on the basis of undesirable binding for ideotypically modulated pharmacoeffectors (IMP); and/or the design of targeting sequences on the basis of reverse complementarity or sequence complementarity. IMPs are designed for optimal use in respective applications, including cancers, autoimmune diseases, infectious diseases, cellular diseases, research, and other applications.

Certain embodiments of the method may have a number of technical advantages. For example, some embodiments may be capable of designing IMPs for the termination of diseased or disease-causing cells. Some other embodiments may include designing IMPs for the enhancement of cells. Some further embodiments may include designing IMPs for the elimination of carriers of zoonotic diseases. Still other embodiments may be designed for the reduction of complications associated with transplants. Various embodiments may include some, all, or none of the above advantages. Particular embodiments may include other advantages.

Other technical features may be readily apparent to one skilled in the art from the following FIGUREs, descriptions, and claims.

### BRIEF DESCRIPTION OF THE DRAWINGS

In the drawings, numbered and lettered objects are consistent across FIGUREs. Solid arrows indicate movement from one step (i.e. routine, subroutine, step) to another. Dashed arrows indicate movement to or from subsequent and previous steps, respectively.

Routines A through D as referred to in the specification are indicated throughout the FIGUREs as solid gray bars with a superimposed white circular label in the upper-left corner. Subroutines or steps that are part of routines are indicated throughout the FIGUREs as solid white bars with thin black borders. Certain subroutines are labeled with a letter indicating routine and number (e.g. A1 is the first labeled subroutine of routine A). In FIGUREs where subroutines are broken down into steps, these steps are indicated with solid white bars with dotted black borders. Gray text with arrows indicates input data as described. Example variables are given in italics. In FIGS. 2 through 8, the Routine or Subroutine depicted is listed in the upper left corner of the FIGURE.

FIG. 1A shows an overview of IMP design software with routines A through D according to embodiments of the disclosure;

FIG. 1B shows an overview of IMP design software with routines A through D according to embodiments of the disclosure;

FIG. 2 shows a breakdown of Routine A from FIG. 1 according to embodiments of the disclosure;

FIG. 3 shows a breakdown of Routine B from FIG. 1 according to embodiments of the disclosure;

FIG. 4 shows a breakdown of Subroutine B1 from FIG. 3 according to embodiments of the disclosure;

FIG. 5 shows a breakdown of Subroutine B2 from FIG. 3 according to embodiments of the disclosure;

FIG. 6 shows a breakdown of Routine C from FIG. 1 according to embodiments of the disclosure;

FIG. 7 shows a breakdown of Subroutine C1 from FIG. 6 according to embodiments of the disclosure according to embodiments of the disclosure;

FIG. 8 shows a breakdown of Routine D from FIG. 1 according to embodiments of the disclosure; and

FIG. 9 is an embodiment of a general purpose computer that may be used in connection with other embodiments of the disclosure to carry out referenced functions.

### DETAILED DESCRIPTION

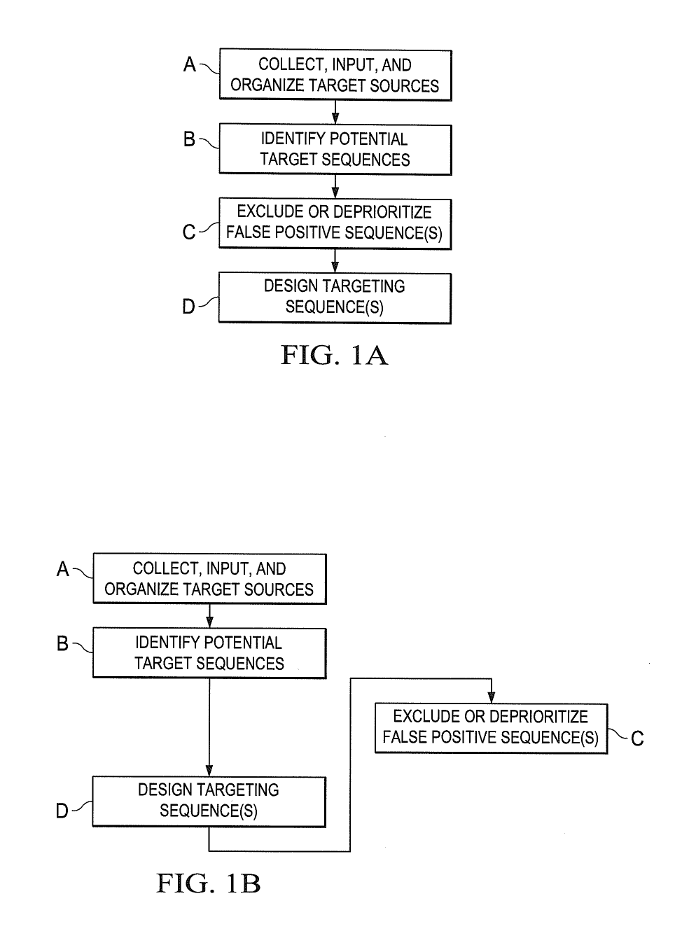

FIGS. 1A through 9, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

Ideotypically Modulated Pharmacoeffectors (IMP or IMPs) as previously disclosed in U.S. patent application Ser. Nos. 12/790,931 and 13/116,747 (both of which are hereby incorporated by reference) may target nucleotide sequences for ideotype-specific cell treatments. In the human body, each cell type expresses a unique assortment of proteins, lipids, sugars, nucleotide sequences, and other metabolites. Each of these is a potential antigen, having epitopes with which a molecule having predetermined affinity can interact. The expression of said antigens—including nucleotide sequences—is modified by the status of the cell and by its environment. This expression becomes further modified in certain states such as viral infection.

The selection of appropriate ideotype-specific nucleotide sequences for targeting may be an essential step to the design and implementation of IMP technology. The design of ideotypically modulated pharmacoeffectors (“IMP” or “IMPs”) is necessarily a process of optimization. As IMPs are programmable to various specifications, this optimization is a non-trivial process. IMPs may be designed for optimal use in respective applications, including cancers, autoimmune diseases, infectious diseases, cellular diseases, research, and other applications. These are examples and should not be considered limiting.

For IMPs to function properly in some anti-HIV embodiments, for instance, IMPs may be designed to target (1) sequences that are conserved among different strains of the virus and (2) sequences that are not found in normal, healthy human cells. The first criterion in this example embodiment—which can be approximated by the statistical concept of sensitivity—ensures that (a) any IMP designed and deployed against HIV in said example embodiment is effective against all strains of the virus and (b) rapid, random mutagenesis in HIV (see Venturi, G. et al. Antiretroviral Resistance Mutations in Human Immunodeficiency Virus Type 1 Reverse Transcriptase and Protease from Paired Cerebrospinal Fluid and Plasma Samples. J. Infect. Dis. 181, 740-745, doi:10.1086/315249 (2000)) does not result in escape mutants. The second criterion in this example embodiment—which can be approximated by the statistical concept of specificity—ensures that (a) IMPs do not kill uninfected cells, (b) IMPs do not interfere with the proper functions of uninfected cells, and (c) host mRNA does not out-compete (i.e. decoy) target sequences for IMPs in infected cells. Some, all, or more of these criteria may be beneficial in other example embodiments.

FIG. 1A shows one example embodiment of an algorithm for designing Ideotypically Modulated Pharmacoeffectors according to one embodiment of the disclosure. In this embodiment, target sources are collected and organized (Routine A), potential individual IMP targets from the source are identified (Routine B), sequences unsuited for IMP targeting are identified and excluded or deprioritized (Routine C), and targeting sequences are designed (Routine D).

FIG. 1B shows another example embodiment of an algorithm for designing Ideotypically Modulated Pharmacoeffectors according to one embodiment of the disclosure. In this embodiment, target sources are collected and organized (Routine A), potential individual IMP targets from the source are identified (Routine B), targeting sequences are designed (Routine D), and sequences unsuited for IMP targeting are identified and excluded or deprioritized (Routine C). It is clear from the flowcharts in FIGS. 1A and 1B that various steps may be performed in different orders to similar effect. Additionally, some steps may be left out in some embodiments. None of the example embodiments disclosed herein should be considered limiting and all routines, subroutines, and steps may be performed in different orders—and in different methods—to similar effect.

A. Example Embodiments of Routine A

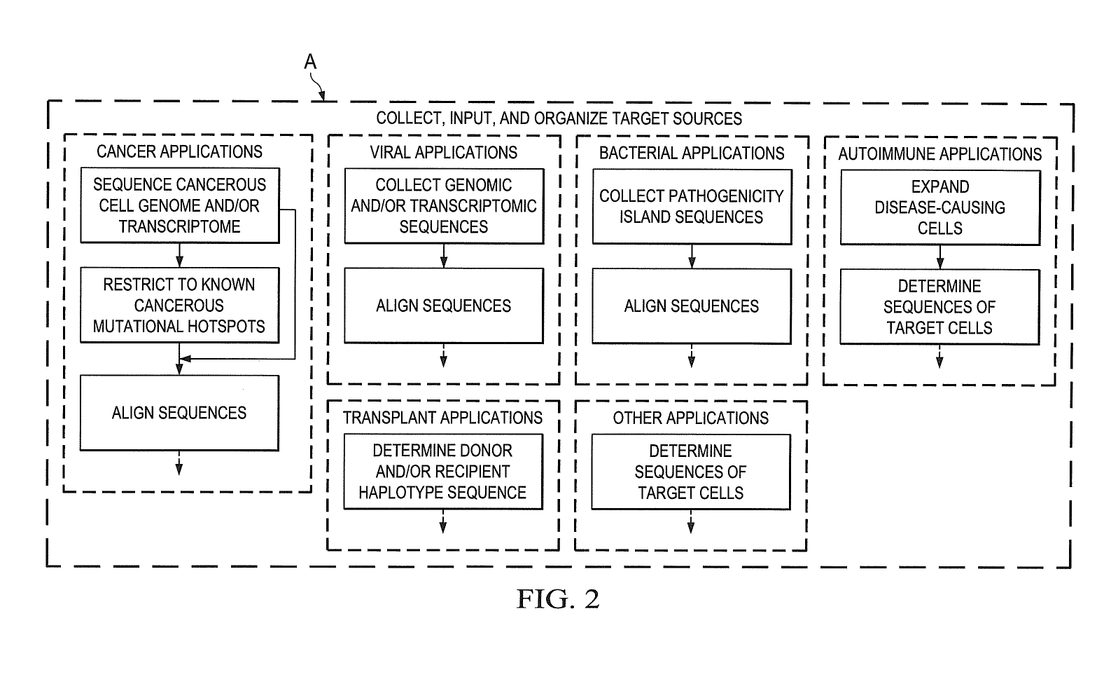

The purpose of an example embodiment of Routine A as depicted in FIG. 2 is to organize sequences appropriately for whatever IMP application is being designed. In one embodiment for IMP design against viral disease as depicted in part of FIG. 2 (labeled Viral Applications), genomic sequences (i.e. the entire nucleotide sequence) of the virus in question may be obtained and aligned with available methods. This is the target source sequence. In another embodiment for IMP design against viral disease as depicted in part of FIG. 2, transcriptome sequences (i.e. transcript sequences) of the virus in question may be obtained and aligned—either together or separately—with available methods. In one example embodiment for IMP design against the viral disease Human Immunodeficiency Virus/Acquired Immunodeficiency Syndrome (HIV/AIDS), publically available genomic sequences may be obtained from Los Alamos National Laboratory databases. See Laboratory, L. A. N. HIV Sequence Database, <http://www.hiv.lanl.gov/>(2012). In other example embodiments, different publically and privately held sequences may be obtained. Sequences from multiple sources may be combined in some embodiments. None of these embodiments should be considered limiting.

In another example embodiment for IMP design against cancerous cells as depicted in part of FIG. 2 (Cancer Applications), cells may be isolated and sequenced in whole or in part and subsequently aligned with available methods. In another example embodiment for IMP design against cancerous cells, sequencing or used sequences may be limited to known mutational hotspots of cancers. This may include the Rb gene, p53, or some other discovered cancer gene (see Futreal, P. A. et al. A census of human cancer genes. Nat. Rev. Cancer 4, 177-183, doi: http://www.nature.com/nrc/journal/v4/n3/suppinfo/nrc1299_S1.html (2004)). Such genes are commonly known to those skilled in the art and may alternatively be causal (i.e. drives pathogenesis) or resultant (i.e. results from pathogenesis) in one or more cancers. In another embodiment for IMP design against cancerous cells, commonly occurring cancer-related sequences may be used to make IMPs prior to an individual's cancer. Thus IMPs may be prepared beforehand and confirmatory sequencing may be performed on a per-case basis. These examples and example embodiments are only some of the potential examples for IMPs in cancers and should not be considered limiting.

In an example embodiment to prevent graft-versus host disease (“GVHD”) and/or transplant rejection in organ transplantation as depicted in FIG. 2 (Transplant Applications), receptor genes or other genes specific to cells that cause GVHD (e.g. natural killer or NK cells, see Dokhelar, M. C. et al. Natural killer cell activity in human bone marrow recipients: early reappearance of peripheral natural killer activity in graft-versus-host disease. Transplantation 31, 61-65 (1981)) may be used as a target sequence to eliminate such cells from the transplant organ prior to transplantation. By eliminating these cells, the risk of GVHD may be substantially reduced or eliminated. In another example embodiment to prevent transplant rejection and/or GVHD, donor cells may be co-cultured with recipient immune cells for the purpose of expanding said cells. These expanded cells—which correspond to transplant-rejecting cells (Meuer, S. C. et al. Triggering of the T3-Ti antigen-receptor complex results in clonal T-cell proliferation through an interleukin 2-dependent autocrine pathway. Proc. Natl. Acad. Sci. U.S.A. 81, 1509-1513 (1984))—may then be sequenced in their antigen-receptor genes to determine potential target sites. The resultant IMPs may then be used to treat the transplant recipient prior to transplant in order to remove transplant-rejecting cells. In another example embodiment to prevent GVHD and/or transplant rejection in organ transplantation, MHC and MHC-restricted receptors may be sequenced in donor and recipient in order to target appropriate cells for removal. Each of these embodiments for the treatment of transplants and transplant recipients are only examples and should not be considered limiting.

In an example embodiment against pathogenic bacterial cells as depicted in FIG. 2 (Bacterial Applications), sequences of pathogenicity islands or pathogen-specific sequences may be collected or sequenced from the pathogen (see Hacker, J., Blum-Oehler, G., Mühldorfer, I. & Tschäpe, H. Pathogenicity islands of virulent bacteria: structure, function and impact on microbial evolution. Mol. Microbiol. 23, 1089-1097, doi:10.1046/j.1365-2958.1997.3101672.x (1997). For instance, pathogenicity island genes like those found in multiply-resistant Streptococcus aureus (MRSA) may be obtained from the National Institutes of Health (see Kuroda, M. et al. Whole genome sequencing of meticillin-resistant Staphylococcus aureus. The Lancet 357, 1225-1240, doi:http://dx.doi.org/10.1016/S0140-6736(00)04403-2 (2001)) and aligned with available methods. This particular and other embodiments may have the added benefit in that they avoid targeting bacteria that are commensal and thus may help to prevent overgrowth of such antibiotic-resistant pathogenic organisms as C. difficile in antibiotic-treated patients (see Cunningham, R., Dale, B., Undy, B. & Gaunt, N. Proton pump inhibitors as a risk factor for Clostridium difficile diarrhoea. J. Hosp. Infect. 54, 243-245, doi:http://dx.doi.org/10.1016/S0195-6701(03)00088-4 (2003)). These sequences may then be aligned with available methods. The foregoing example embodiments are examples only and should not be considered limiting.

In an example embodiment against autoimmunity-causing or -exacerbating cells as depicted in FIG. 2 (Autoimmune Applications), autoimmune cells from a patient may be isolated and expanded by exposure to autoimmune antigens (see Epperson, D. E., Nakamura, R., Saunthararajah, Y., Melenhorst, J. & Barrett, A. J. Oligoclonal T cell expansion in myelodysplastic syndrome: evidence for an autoimmune process. Leuk. Res. 25, 1075-1083 (2001)). These enriched cells may then be sequenced. Specific antigen receptor genes that are unique to the autoimmunity-causing cells may then be used as targets. Multiple sequences may be identified for multiple clonal sets. This embodiment is only an example and should not be considered limiting.

Many other embodiments may exist in the previously-described embodiments and other applications and embodiments. One example embodiment as depicted in FIG. 2 (Other Applications) may comprise simple determination of sequences found in target cells.

In applications where multiple source sequences are used (e.g. in mutable viral diseases where viruses often have mutational hotspots that would make poor IMP targets), these sequences may be aligned using one or more of many available methods. These methods are often familiar to those skilled in the art and include CLUSTAL alignment techniques (Higgins, D. G., Bleasby, A. J. & Fuchs, R. CLUSTAL V: improved software for multiple sequence alignment. Computer applications in the biosciences: CABIOS 8, 189-191, doi:10.1093/bioinformatics/8.2.189 (1992)), pattern alignments (Smith, R. F. & Smmith, T. F. Pattern-induced multi-sequence alignment (PUMA) algorithm employing secondary structure-dependent gap penalties for use in comparative protein modelling. Protein Eng. 5, 35-41, doi:10.1093/protein/5.1.35 (1992)), hierarchical clustering techniques (Corpet, F. Multiple sequence alignment with hierarchical clustering. Nucleic Acids Res. 16, 10881-10890, doi:10.1093/nar/16.22.10881 (1988)), and other methods. None of the above methods should be considered limiting.

B. Example Embodiments of Routine B

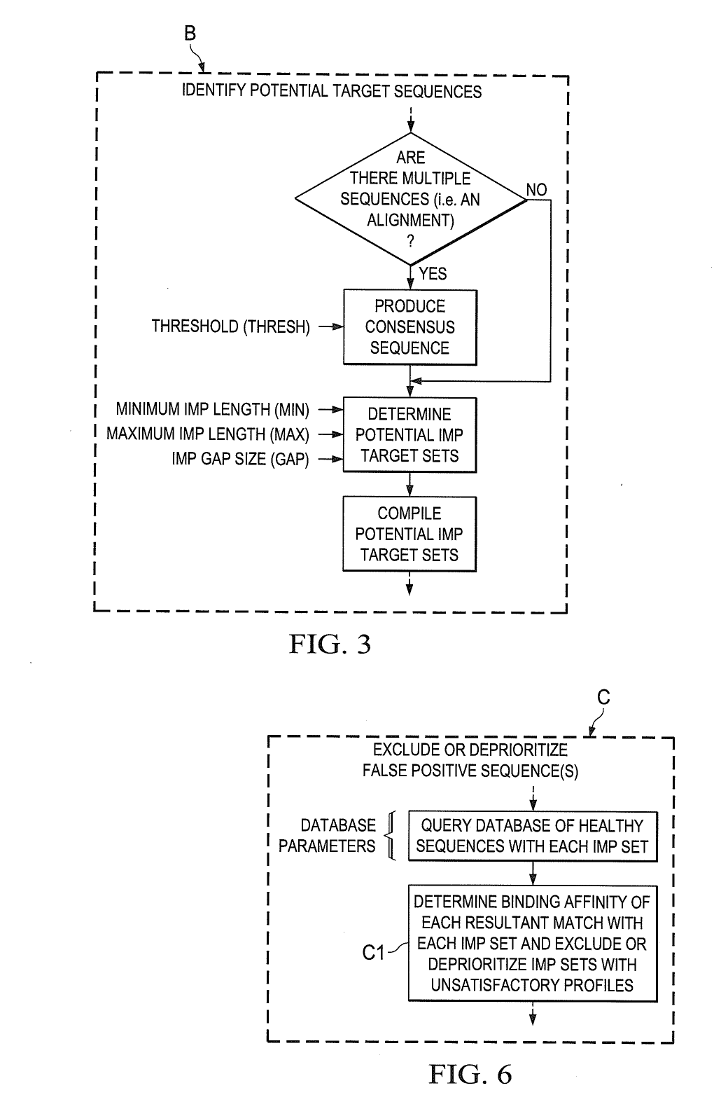

The purpose of Routine B as depicted in FIG. 3 is to identify potential target sequences in the source sequences available either by input or by the use of Routine A. Please note that in some embodiments Routine A and other routines may not be necessary.

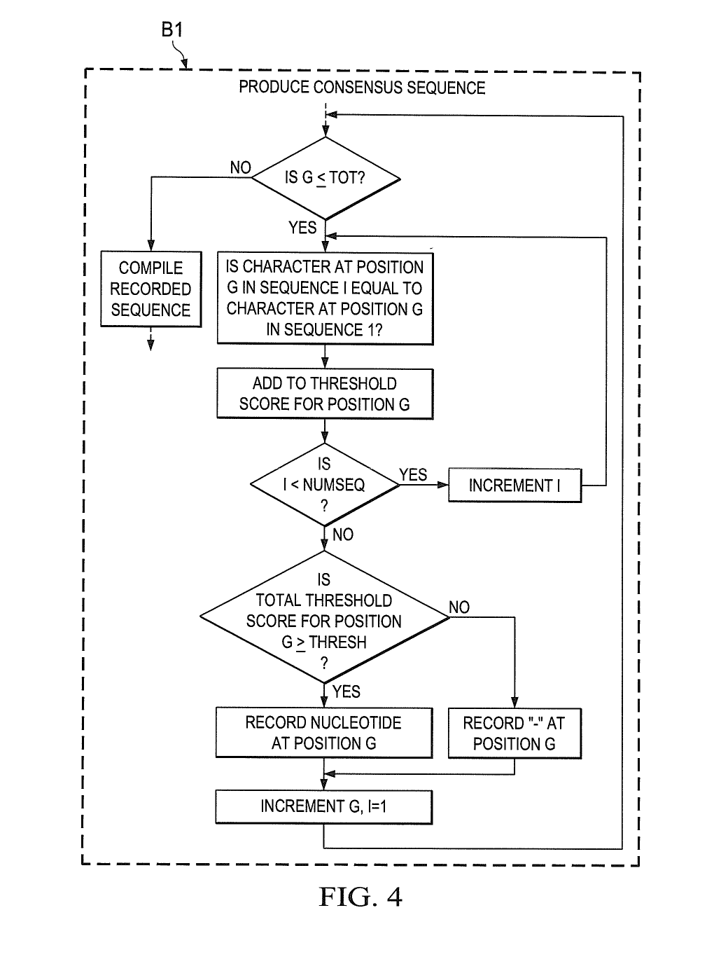

In embodiments where multiple sequences were aligned in Routine A, a consensus sequence may be generated given a certain threshold. FIG. 4 depicts one embodiment subroutine (Subroutine B1) to produce a useable consensus sequence. The threshold, an input number between 0 and 1, represents the proportion of a given set of sequences in an alignment that match the first sequence at any given nucleotide. For example, the following set of four aligned sequences differs at base 4 of sequence B (A→G in bold and underlined).

Sequence A
5′-ATAAATCGAG-3′
Sequence B
5′-ATAGATCGAG-3′
Sequence C
5′-ATAAATCGAG-3′
Sequence D
5′-ATAAATCGAG-3′

In an embodiment Subroutine B1 depicted in FIG. 4, tot represents the total length in bases of the consensus sequence (10 in this example), numseq represents the number of total sequences (4 in this example), g represents the base character position (starting at 1 and eventually iterating through tot), and i represents the sequence number (also starting at 1 and eventually iterating through numseq). Thus an array of (i,g) offers a coordinate system for uniquely identifying each nucleotide base. In this embodiment, each base from g=0 to g=(tot) is considered for each sequence A through D and queried as to whether it matches Sequence A at position g. In this example, base (1,1)—which is the starting A—is first queried as to whether it matches itself. This results in the addition of a fraction 1/numseq at position g. Next, i is incremented and the next base (2,1)—which is the A in sequence B—is queried as to whether it matches the same base in the first sequence (1,1). As it does in this example, the addition of a fraction 1/numseq at position is made. For reference, position g=1 at this step has a value of 0.5 because the first two sequences queried at this position matched the first sequence and each added 1/numseq (1/4). Two more iterations of i result in a score of 1 because all four sequences at position g are equal to the first.

In the same or similar embodiments, once i is incremented to numseq it is determined whether the threshold score at position g is greater than or equal to the threshold score required by user input (depicted as the gray Threshold and arrow in FIG. 3 and as the variable thresh in FIG. 4). If this is true—as it would be in this example if a threshold score of thresh=1 (i.e. complete consensus) were required by user input—then the nucleotide from (1,g)—in this case A—would be recorded in position g in the consensus sequence. If this is false, however, the example records a “-” to denote that this particular base is unsuitable for targeting.

In the same or similar embodiments, once the consensus nucleotide or “-” (or some other character to denote that no consensus has been made at a given site) is recorded in the consensus sequence, g is incremented and i is set to 1. The same process as above is repeated to determine a threshold score for position 2 (i.e. g=2), then position 3, et cetera. Note that in these examples, position (2,4) results in the addition of 0 to the threshold score because the nucleotide in that position—a G—does not match that at position (1,4)—an A. If the variable thresh is 1 in this example, a “-” will be added for position 4 (i.e. g=4) in the consensus sequence because a threshold score of 0.75 is less than I. Thus in the above example embodiment and example sequences with a user setting of thresh=1, we would obtain the following output:

Consensus sequence:
5′-ATA-ATCGAG-3′

Note the “-” symbol at position 4, as no sufficient consensus was reached at that base.

The scoring system in this example embodiment is only listed as an example and other methods for determining a consensus sequence may be used. Thus this example should not be considered limiting and many consensus sequence-determining methods are applicable and available (see, for instance, Schneider, T. D. & Stephens, R. M. Sequence logos: a new way to display consensus sequences. Nucleic Acids Res. 18, 6097-6100, doi:10.1093/nar/18.20.6097 (1990)).

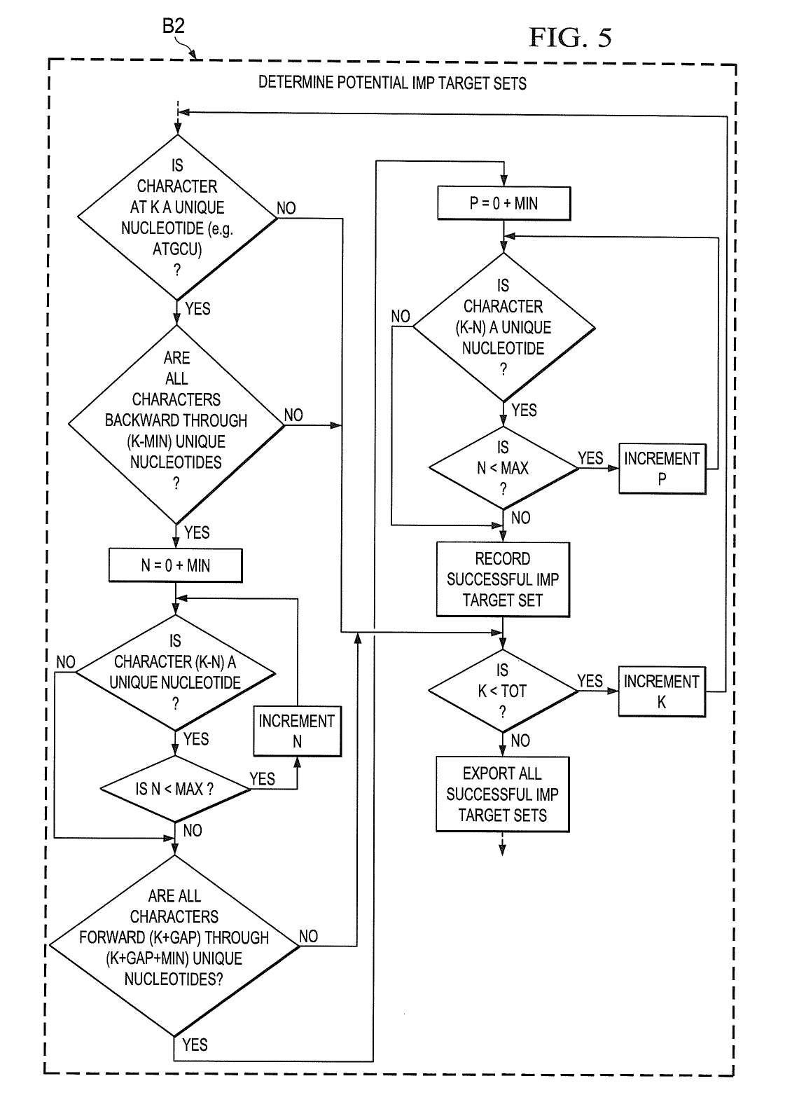

From consensus sequences or simply input sequences from Routine A or some other source, as disclosed, potential IMP target sets must be determined. A non-limiting example embodiment depicted in FIG. 5 is one way this can be done. Variables input by the user include Minimum IMP length (min), which sets the minimum length allowed for any given IMP detection domain; Maximum IMP length (max), which sets the maximum length allowed for any given IMP detection domain; and IMP gap size (gap), which sets the distance between two IMP detection domains in a given embodiment. Variables determined by the program include tot—the total consensus sequence length—and k, an incremented variable that begins at 1 and is comparable to variable g in FIG. 4 in that it also increments up to (tot). Variables n and p are declared in the course of the algorithm. These variables, variable names, and techniques are only examples and should not be considered limiting in any way.

Each of the above variables may have optimal settings. Minimum IMP length (min), in some embodiments, may be set to more than twenty base pairs (>20 bp) in order to decrease the probability of unwanted binding (see Routine C). Maximum IMP length (max), in some embodiments, may be set to less than thirty base pairs (<30 bp) in order to increase the probability of cell entry. Very importantly, IMP gap size (gap) will be set in some embodiments to multiples of nine to eleven base pairs (9, 10, 11; 19, 20, 21; 29, 30, 31; etc bp) in order to ensure that the stereochemistry of IMPs are optimal as has been determined experimentally in some embodiments (data not shown).

In an example embodiment Subroutine B2 depicted in FIG. 5, k is incremented and IMP sets are checked first for an appropriately conserved minimum IMP sequence on the left (5′ in some embodiments, also called IMP A for convenience) stretching from k to (k−n). If no such minimum sequence exists, k is incremented and no potential target site is recorded at that site. If a minimum sequence length is detected, however, variable n is then incremented until either (a) n=max and therefore the maximum length of IMP A has been reached, or (b) the character at position (k−n) is “-” (i.e. a nucleotide position at which it has been determined no IMP should be placed given its inappropriate consensus; in other words, threshold score<thresh). Once the IMP A length is determined, the potential for IMP B (the right or 3′ IMP in some embodiments) is determined. First, the algorithm checks whether characters from position (k+gap) to position (k+gap+min) comprises all unique and sufficiently conserved nucleotides (in this example embodiment, no “-”). If no such minimum sequence exists, k is incremented and no potential target site is recorded at that site. If an acceptable minimum sequence length is detected, however, variable p (analogous to variable n for IMP A) is then incremented until either (a) p=max and therefore the maximum length of IMP B has been reached, or (b) the character at position (k+gap+p) is “-” (i.e. a nucleotide position at which it has been determined no IMP should be placed given its inappropriate consensus; threshold score<thresh). At this point, a successful IMP target set—IMP A running from bases (k−n) to k and IMP B running from (k+gap) to (k+gap+p)—is recorded. Note that nucleotides k through (k+gap) may vary in value without necessarily affecting IMP function. Variable k is then incremented if k<tot and the cycle continues until k=tot. Note that appropriate adjustments known to those skilled in the art may be necessary to make such an algorithm function when k<min and k>(tot−min) or in other circumstances. The above examples are given for example only and should not be considered limiting.

C. Example Embodiments of Routine C

The purpose of Routine C as depicted in an embodiment in FIG. 6 is to exclude or deprioritize those sequences identified in Routine B (or, in some embodiments, Routine D or from some other source) which have unwanted off-target binding. This off-target binding may be to sequences found in normal, healthy human cells in an example embodiment. In certain embodiments similar to this example embodiment, a transcriptome database such as NCBI's human transcriptome (alt_CRA_TCAGchr7v2_contig, for instance—Health, N. I. o. BLAST Databases, <ftp://ftp.ncbi.nih.gov/blast/> (2012)) may be queried. Queries may be run with open-source software such as NCBI BLASTN under a GNU General Public License. (see Altschul, S. F., Gish, W., Miller, W., Miller, E. W. & Miller, D. J. Basic local alignment search tool. J. Mol. Biol. 215, 403-410 (1990)). This off-target binding may further be sequences found in non-pathogenic or non-targeted bacteria or viruses, in another example embodiment. A simple consensus tool as described previously in Routine B may be used to query a database in some embodiments. Low-stringency parameters (e.g. small word size, low identity requirement, and appropriate e value) may help ensure that any and all potential target matches in the database are discovered for further evaluation.

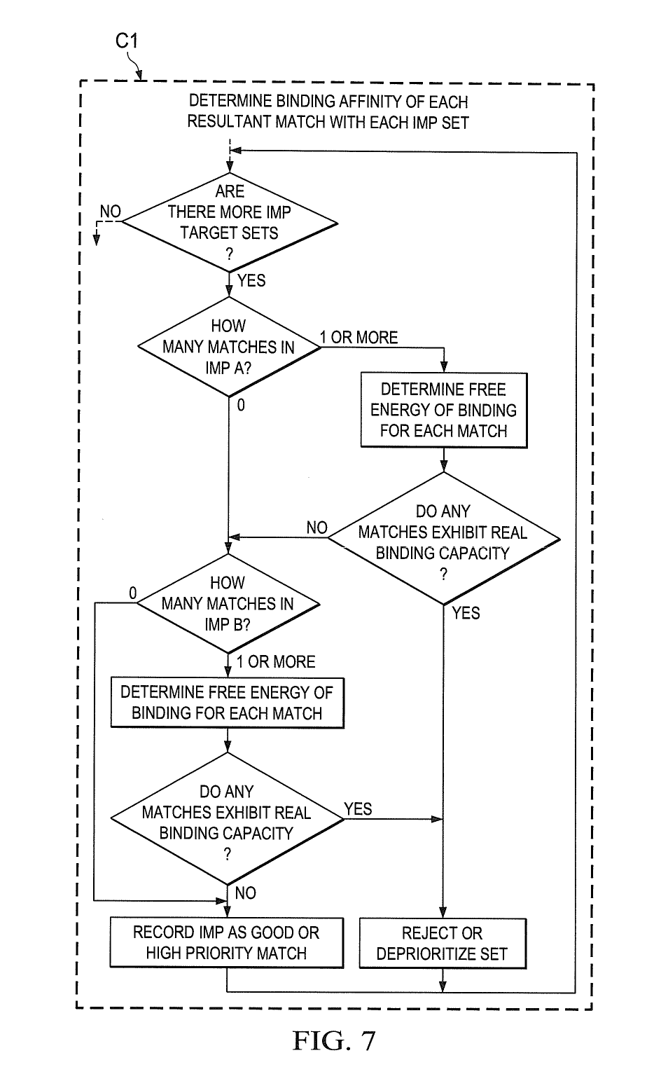

Matches discovered by such queries are frequently not binding matches and thus may require validation by thermodynamic or physical means. For instance, a query of sequence 5′-TTTGAAAATGTAAAATTCGATAT-3′ against NCBI's human transcriptome database given low-stringency parameters uncovers a number of transcriptome hits. While some of these hits are expected to bind with some affinity (e.g. 5′-TTTGAAAATGTAAAATTC-3′ with an approximate Gibbs free energy of −1.14) others will not be expected to bind favorably (e.g. 5′-TTTGAAAATGTAAAA-3′ with an approximate Gibbs free energy of +1.01). In order to evaluate these matches in some example embodiments, all matching pairs may be tested per Subroutine C1 as depicted in FIG. 7. For each match a Gibbs free energy (ΔG) may be determined in some embodiments using the Wetmur method. Wetmur, J. G. in Encyclopedia of Molecular Biology and Molecular Medicine Vol. 4 (ed Robert A. Meyers) 235-239 (Verlagsgesellschaft mbH, 1996). In this and other embodiments, an acceptable threshold ΔG may be determined by the user. In other embodiments various other methods and combinations of methods may be used to determine the binding affinity of nucleotide sequence duplexes (Nelson, B. P., Grimsrud, T. E., Liles, M. R., Goodman, R. M. & Corn, R. M. Surface Plasmon Resonance Imaging Measurements of DNA and RNA Hybridization Adsorption onto DNA Microarrays. Anal. Chem. 73, 1-7, doi:10.1021/ac0010431 (2000); Tulpan, D., Andronescu, M. & Leger, S. Free energy estimation of short DNA duplex hybridizations. BMC Bioinformatics 11, 105 (2010)) or to determine the binding affinity of non-nucleotide IMP detection domain(s) to nucleotide sequences. In still another embodiment, physical means (e.g. the synthesis of the nucleotide strand(s) in question and physical testing of binding properties given certain conditions) may be used.

In other embodiments, Routine B may include the exclusion of potential targets on the basis of homology to healthy human cells. In still other embodiments, Routine B may include the exclusion of potential target sites on the basis of homology to non-pathogenic or non-targeted bacteria, parasites, or viruses. In still other embodiments, Routine B may include the exclusion of potential target sites that are found in cells that are not the cells of interest to the IMP design. Each of these embodiments is given as an example and should not be considered limiting.

D. Example Embodiments of Routine D

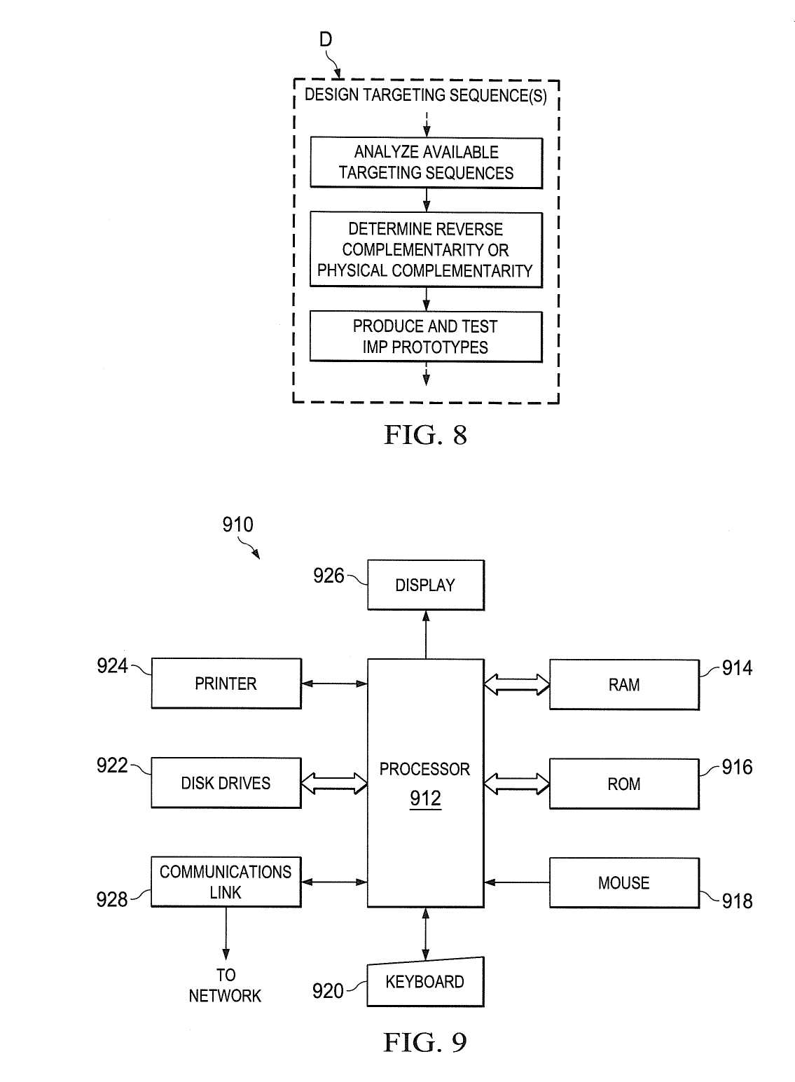

The purpose of Routine D as depicted in an embodiment in FIG. 8 may be in some embodiments to design the targeting sequence(s) to target the sequences identified in other routines. Available targeting sequences may in some embodiments be analyzed for their utility in certain embodiments. For instance, the existence or non-existence of hairpin loops in RNA sequences may be material to the utility of IMPs designed against said targets. These may be excluded or prioritized accordingly. In still other embodiments, targeting sequences may be analyzed for their likelihood of binding various targets and at desirable affinities, including desirable affinities versus the original.

Additionally, some embodiments may include the testing of “wobble” in target nucleotide sets (Agris, P. F., Vendeix, F. A. P. & Graham, W. D. tRNA's Wobble Decoding of the Genome: 40 Years of Modification. J. Mol. Biol. 366, 1-13, doi:http://dx.doi.org/10.1016/j.jmb.2006.11.046 (2007)) in order to determine whether some leniency may be allowed in the IMP design. For instance, the target 5′-ATGCCA-3′ may be targeted in one embodiment by a sequence 5′-TGGCAT-3′ per natural complementarity (Casey, J. & Davidson, N. Rates of formation and thermal stabilities of RNA:DNA and DNA:DNA duplexes at high concentrations of formamide. Nucleic Acids Res. 4, 1539-1552, doi: 10.1093/nar/4.5.1539 (1977)) and have a favorable thermodynamic profile for binding. If the same sequence is targeted in another embodiment by a sequence 5′-TGCCAT-3′ (with a mismatch in position 3, G→C) it would be expected that this targeting would have a less favorable thermodynamic profile for binding. This may not, however, exclude the use of this IMP sequence to target said sequence in some embodiments. Indeed the use of the first targeting sequence (5′-TGGCAT-3′) to target the first target sequence (5′-ATGCCA-3′) may also have a desirable characteristic of binding a common mutant target sequence—for example, 5′-ATGGCA-3′—at some favorable thermodynamic profile, although this profile may or may not be as favorable as with the first, completely complementary target. These thresholds and determinations may be set by the end user.

Additionally, some embodiments may include the exclusion or deprioritization of target sites that may be less suitable because of hairpin structures, high-mutation sites, or other concerns. IMP prototypes may be produced and tested for efficacy in any given embodiment. Further, high-mutation sites in HIV, for instance, can be identified from the Los Alamos National Laboratory HIV-1 reference sequence. Laboratory, L. A. N. HIV Sequence Database, <http://www.hiv.lanl.gov/> (2012).

The example embodiments listed here and throughout the disclosure are for illustrative purposes only and should not be considered limiting.

E. Some Example Embodiments of Software Code

The following is an example embodiment Perl script algorithm that may be used to design IMPs that are both specific and sensitive in the target application. Although Perl is used in this example, a variety of other programming languages and programs may be utilized.

The first script in the present embodiment is used to call other scripts, named ProgA, ProgB, and ProgC. In similar example embodiments, these names and the architecture of the software may be changed substantially but to the same effect. While this embodiment is functional on the system intended, it should be considered neither a preferred system nor limiting.

query.pl:

```
#! usr/bin/perl
      print “Running IMPFinder...\n\n”;
  @args1 = (“perl.exe”, “ProgA.pl”); #run to input sequence
  and determine sets
  system(@args1) == 0
    or die “system @args1 failed: $?”;
  @args2 = (“perl.exe”, “ProgB,pl”); #run to blast against database
  system(@args2) == 0
    or die “system @args2 failed: $?”;
      @args3 = (“perl.exe”, “ProgC.pl”); #check matches and report
  system(@args3) == 0
    or die “system @args2 failed: $?”;
```

Script ProgA in an example embodiment may disclose certain aspects of Routines A, B, and C as well as other parts of the present invention, including organization of sequence(s), finding of IMPs, and preparing IMPs for database query given certain assumed variables and user inputs. This embodiment should not be considered limiting as other variables, variable names, orders of operation, commands, methods, languages, tasks, assumptions, and code may be used in other similar embodiments without loss of utility. The present embodiment demonstrates that different orders of operation than those disclosed in the FIGUREs may be used to similar effect.

ProgA.pl:

```
#! usr/bin/perl
# Set up parameters
    $threshold = 1; # percent homology necessary for inclusion
    $inputsequences = “input.fasta”; # fasta file
    $IMP_len = 20; # Target site length
    $IMP_len_min = $IMP_len;
    $IMP_len_max = $IMP_len + 10;
    $IMP_gap = 10; # Gap length
# clear tmp directory
    opendir(DIR, “tmp”);
    @FILES=readdir(DIR);
    closedir(DIR);
    $u=0;
    while ($u <= ($#FILES)) {
        $u++;
        unlink(‘tmp/’.$FILES[$u].”);
    }
# Open the fasta file and create consensus sequence
    print “\nOpening file \“$inputsequences\”...\n”;
    open (INPUTFILE1, $inputsequences) || die
    (“Could not open file!”);
    #$raw_data=<INPUTFILE1>;
    $sequence=”;
    while (<INPUTFILE1>) {
    chomp;
    ($Start) = split(“\n”);
        $sequence .= $Start;
    }
    print “Parsing sequences...\n”;
    @sequencearray = split(/>/,$sequence);
    $len1 = @sequencearray − 1;
    $len2 = length(@sequencearray[1]) − 1;
    $g = 0;
    while ($g < $len2) {
        $g++;
        $i = 0;
        $score = 0;
        while ($i < $len1) {
            $i++;
            $b1 = substr(@sequencearray[1],$g,1);
            $b2 = substr(@sequencearray[$i],$g,1);
            if (“$b1” eq “$b2”) { $score++; }
        }
        $totalscore[$g] = ($score / $i);
    }
    print “Producing consensus sequence with a threshold of: $threshold \n”;
    $g = 0;
    while ($g < $len2) {
        $g++;
        if ($totalscore[$g] >= $threshold) { $inputsequence .=
substr(@sequencearray[1],$g,1); } else { $inputsequence .= “-”; }
    }
    close (INPUTPILE1);
# Format input
$inputsequence =~ s/ //g; # Remove spaces
$inputsequence = lc($inputsequence); # lower case
$inputsequence =~ tr/b,d-f,h-s,u-z/-/; # remove ambiguous
$inputsequence =~ tr/0-9,“ ”//d;
$dashrepeat = (“-” x 2 x $IMP_len_min);
$inputsequence = “$dashrepeat$inputsequence$dashrepeat”;
# Determine whether you have a potential set and push to variables hits1 and hits2
# Backward find length method
    print “Searching for IMP target sets in consensus...\n\n”;
    $k=$IMP_len_min;
    $m=0;
    while ($k < length($inputsequence)) {
        $k++;
        if (substr($inputsequence,$k,1) eq “-”) { } else {
            $n=0; # counter for looking backward
            $o=0; # backward length of set
            $p=0; # counter for looking forward
            $q=0; # forward length of set
            # Look back to determine length of potential IMP A
            while ($n < ($IMP_len_max)) {
                $n++;
                if (substr($inputsequence,($k-$n),1) eq “-”) {
$n=$IMP_len_max+1; } else { $o++; }
            }
            # Look forward to determine length of potential IMP B
            while ($p < ($IMP_len_max)) {
                $p++;
                if (substr($inputsequence,($k+$IMP_gap+$p),1) eq “-”) {
$p=$IMP_len_max+1; } else { $q++; }
            }
            # If there's a sufficient set, record it:
            if (($o >= $IMP_len_min) && ($q >= $IMP_len_min)) {
                $m++;
                $hits1[$m] = substr($inputsequence,$k-$o,$o);
                $hitstart[$m] = ($k − length($dashrepeat) + 2 − $IMP_len_min);
                $hits2[$m] = substr($inputsequence,$k + $IMP_gap,$q);
                print (“ ” x ($IMP_len_max − $o));
                print $hits1[$m];
                print (“ ” x $IMP_gap);
                print $hits2[$m];
                print “\n”;
            }
        }
    }
# Create file for query_blastn.pl to draw from
    open (MYFILE2, ‘>report.txt’);
    print MYFILE2 “TargID TargStart  SequenceA  SequenceB\n”;
    close (MYFILE2);
# Build file with queries to draw from:
$set_num=$#hits1;
if($set_num >= 0) {
    print “\nFound “.($set_num).” potential IMP target sets.\nPreparing to run sequences...\n”;
    } else {
    print “\nNo targets fit your parameters. Please try again.\n”;
    die;
    }
$n=0;
while ($n < $set_num) {
    $n++;
    open (MYFILE2, ‘>>report.txt’);
    print MYFILE2 $n.“  “.$hitstart[$n].” “.$hits1[$n].”  “.$hits2[$n].”\n”;
    close (MYFILE2);
    }
```

Script ProgB in an example embodiment may disclose certain aspects of Routines A and C as well as other parts of the present invention, including the organization of sequences and the querying of a human transcriptome database given certain assumed variables and user inputs. This embodiment should not be considered limiting as other variables, variable names, orders of operation, commands, methods, languages, tasks, assumptions, and code may be used in other similar embodiments without loss of utility. The present embodiment demonstrates that different orders of operation than those disclosed in the FIGUREs may be used to similar effect.

ProgB.pI:

```
#! usr/bin/perl
# Set blast parameters
$targmax = “100”; #maximum number of target sequences to find
$wordsize = “15”; #word size to search with
$identity = “100”; # percentage of identity needed
$databasename = “alt_CRA_TCAGchr7v2_contig”; # which database to check against (RASV_human
is human transcriptome with alternative variants)
$evalue = “100”;
$strand = “-strand plus”; # which strand to search
$remotecheck = “”; # whether to run at NCBI or local
$processors = “-num_threads 2”; # to determine how many threads are running
# Read in targets for reading from blastlist.txt
$i=0;
open (FILE, ‘report.txt’);
while (<FILE>) {
    $i++;
    chomp;
    ($TargID, $Start, $A_targ, $B_targ) = split(“\t”);
    $targA[$i − 1] = $A_targ;
    $targB[$i − 1] = $B_targ;
    }
close (FILE);i
# Run query for each set
print “Confirmed “.$#targA.” IMP target sets\n\n”;
$i=0;
while ($i < $#targA) {
    $i++;
    # Build first FASTA
        open (MYFILE, ‘>input1.fasta’);
        print MYFILE “>Test1\n”.$targA[$i].“\n”;
        close (MYFILE);
        $input = “input1.fasta”;
        $outfmt1 = “\”6 sacc sstart send evalue positive mismatch qstart qend qseq sseq qlen
slen \“”;
        $out1 = “tmp/outA-”.$i.“\.txt”;
        $query = “blastn.exe -task blastn-short “.$remotecheck.”-max_target_seqs
“.$targmax.” “.$processors.” -query “.$input.” -db “.$databasename.” -evalue “.$evalue.” “.$strand.”-
perc_identity “.$identity.” -word_size “.$wordsize.” -outfmt “.$outfmt1.” -out “.$out1.””;
    # Build second FASTA
        open (MYFILE, ‘>input2.fasta’);
        print MYFILE “>Test1\n”.$targB[Si].“\n”;
        close (MYFILE);
        $input = “input2.fasta”;
        $outfmt2 = “\”6 sacc sstart send evalue positive mismatch qstart qend qseq sseq qlen
slen \””;
        $out2 = “tmp/outB-”.$i.“\.txt”;
        $query2 = “blastn.exe -task blastn-short “.$remotecheck.”-max_target_seqs
“.$targmax.” “.$processors.” -query “.$input.” -db “.$databasename.” -evalue “.$evalue.” “.$strand.” -
perc_identity “.$identity.” -word_size “.$wordsize.” -outfmt “.$outfmt2.” -out “.$out2.””;
    # Run first query
        print “Running sequence: “.$targA[$i].” on database “.$databasename.“\n”;
        $run1 = system($query);
        print “Running sequence: “.$targB[$i].” on database “.$databasename.”\n”;
        $run2 = system($query2);
    # print $targA[$i].” and “.$targB[Si].“\n”;
    }
```

Script ProgC in an example embodiment may disclose certain aspects of Routines A, C, and D as well as other parts of the present invention, including the calculation of certain thermodynamic properties and prioritization of matches given certain assumed variables and user inputs. This embodiment should not be considered limiting as other variables, variable names, orders of operation, commands, methods, languages, tasks, assumptions, and code may be used in other similar embodiments without loss of utility. The present embodiment demonstrates that different orders of operation than those disclosed in the FIGUREs may be used to similar effect.

ProgC.pl:

```
#! usr/bin/perl
# Set parameters
        # Thermodynamic pair values in kcal/mol at 37 C (from Tulpan, D., Andronescu, M. & Leger,
S. Free energy estimation of short DNA duplex hybridizations. BMC Bioinformatics 11, 105 (2010).)
                $dg_aatt = −0.838948;
                $dg_at = −0.375235;
                $dg_ta = −0.144092;
                $dg_catg = −1.406794;
                $dg_gatc = −0.938327;
                $dg_gtac = −1.406794;
                $dg_ctag = −1.323547;
                $dg_cg = −0.967002;
                $dg_gc = −0.711466;
                $dg_ggcc = −1.698997;
                $Gi = 2.2; # Gi, 2.2 in Wetmur
        # Thermodynamic mispairing values in kcal/mol (from Wetmur et al)
                $gmismatch = 2.9;
                $emismatch = 3.7;
                $nongcmismatch = 4;
                $probgmismatch = .5;
                $probcmismatch = 0.5*(2/3);
                $probnongcmismatch = 1/6;
                # $mispairpenalty = $gmismatch*$probgmismatch + $cmismatch*$probcmismatch +
$nongcmismatch*$probnongcmismatch;
                $mispairpenalty = 1.4;
# Get directory list of tmp (where blast output from ProgB is)
        opendir(DIR, “tmp”);
        @FILES= readdir(DIR);
        closedir(DIR);
# Get list of sequences from ProgA
        open (FILE1, ‘report.txt’);
        $q=0;
        while (<FILE1>) {
        $q++;
        chomp;
        ($SeqID, $targstart, $A_targ, $B_targ) = split(“\t”);
                $SeqID_match[Sq] = $SeqID;
                $SeqA[$q] = $A_targ;
                $SeqB[Sq] = $B_targ;
                $SeqID_start[Sq] = $targstart;
        }
        close (FILE1);
# Run through files and print out results
open (MYFILE, ‘>finalreport.txt’);
print MYFILE “SeqID  Start  SeqA  SeqB  MatchA  MatchB \n”;
close (MYFILE);
$p=1;
while ($p <= ($#FILES − 1)/2) {
        $p++;
        # print $FILES[$p];
        $SeqID = substr(substr($FILES[$p], 5), 0 , −4);
        open (MYFILE, ‘>>finalreport.txt’);
        print MYFILE $SeqID;
        print MYFILE “ ”;
        print MYFILE $SeqID_start[$SeqID+1];
        print MYFILE “ ”;
        print MYFILE $SeqA[$SeqID+1];
# Do thermodynamic calculations for A (per methodology from Wetmur, J. G. in Encyclopedia of
Molecular Biology and Molecular Medicine Vol. 4 (ed Robert A. Meyers) 235-239
(Verlagsgesellschaft mbH, 1996))
                        $r=0;
                        $thermoA = 0;
                        # add all pairwise matches
                                while ($r<length($SeqA[$SeqID+1])) {
                                        $r++;
                                        if (substr($SeqA[$SeqID+1],$r-1,2) eq “aa”) { $thermoA
= $thermoA+$dg_aatt; }
                                        if (substr($SeqA[$SeqID+1],$r-1,2) eq “tt”) { $thermoA
= $thermoA+$dg_aatt; }
                                        if (substr($SeqA[$SeqID+1],$r-1,2) eq “at”) { $thermoA
= $thermoA+$dg_at; }
                                        if (substr($SeqA[$SeqID+1],$r-1,2) eq “ta”) { $thermoA
= $thermoA+$dg_ta; }
                                        if (substr($SeqA[$SeqID+1],$r-1,2) eq “ca”) { $thermoA
= $thermoA+$dg_catg; }
                                        if (substr($SeqA[$SeqID+1],$r-1,2) eq “tg”) { $thermoA
= $thermoA+$dg_catg; }
                                        if (substr($SeqA[$SeqID+1],$r-1,2) eq “gt”) { $thermoA
= $thermoA+$dg_gtac; }
                                        if (substr($SeqA[$SeqID+1],$r-1,2) eq “ac”) { $thermoA
= $thermoA+$dg_gtac; }
                                        if (substr($SeqA[$SeqID+1],$r-1,2) eq “ct”) { $thermoA
= $thermoA+$dg_ctag; }
                                        if (substr($SeqA[$SeqID+1],$r-1,2) eq “ag”) { $thermoA
= $thermoA+$dg_ctag; }
                                        if (substr($SeqA[$SeqID+1],$r-1,2) eq “ga”) { $thermoA
= $thermoA+$dg_gatc; }
                                        if (substr($SeqA[$SeqID+1],$r-1,2) eq “tc”) { $thermoA
= $thermoA+$dg_gatc; }
                                        if (substr($SeqA[$SeqID+1],$r-1,2) eq “cg”) { $thermoA
= $thermoA+$dg_cg; }
                                        if (substr($SeqA[$SeqID+1],$r-1,2) eq “gc”) { $thermoA
= $thermoA+$dg_gc; }
                                        if (substr($SeqA[$SeqID+1],$r-1,2) eq “gg”) { $thermoA
= $thermoA+$dg_ggcc; }
                                        if (substr($SeqA[$SeqID+1],$r-1,2) eq “cc”) { $thermoA
= $thermoA+$dg_ggcc; }
                                }
                        # subtract Gi
                                $thermoA = $thermoA + $Gi;
        print MYFILE “ (dG=“.substr(($thermoA),0,5).”)”;
        print MYFILE “ ”;
        print MYFILE $SeqB[$SeqID+1];
                # Do thermodynamic calculations for B
                        $r=0;
                        $thermoB = 0;
                        # add all pairwise matches
                        while ($r<length($SeqB[$Seq1D+1])) {
                                $r++;
                                if (substr($SeqB[$SeqID+1],$r-1,2) eq “aa”) { $thermoB =
$thermoB+$dg_aatt; }
                                if (substr($SeqB[$SeqID+1],$r-1,2) eq “tt”) { $thermoB =
$thermoB+$dg_aatt; }
                                if (substr($SeqB[$SeqID+1],$r-1,2) eq “at”) { $thermoB =
$thermoB+$dg_at; }
                                if (substr($SeqB[$SeqID+1],$r-1,2) eq “ta”) { $thermoB =
$thermoB+$dg_ta; }
                                if (substr($SeqB[$SeqID+1],$r-1,2) eq “ca”) { $thermoB =
$thermoB+$dg_catg; }
                                if (substr($SeqB[$SeqID+1],$r-1,2) eq “tg”) { $thermoB =
$thermoB+$dg_catg; }
                                if (substr($SeqB[$SeqID+1],$r-1,2) eq “gt”) { $thermoB =
$thermoB+$dg_gtac; }
                                if (substr($SeqB[$SeqID+1],$r-1,2) eq “ac”) { $thermoB =
$thermoB+$dg_gtac; }
                                if (substr($SeqB[$SeqID+1],$r-1,2) eq “ct”) { $thermoB =
$thermoB+$dg_ctag; }
                                if (substr($SeqB[$SeqID+1],$r-1,2) eq “ag”) { $thermoB =
$thermoB+$dg_ctag; }
                                if (substr($SeqB[$SeqID+1],$r-1,2) eq “ga”) { $thermoB =
$thermoB+dg_gatc; }
                                if (substr($SeqB[$SeqID+1],$r-1,2) eq “tc”) { $thermoB =
$thermoB+$dg_gatc; }
                                if (substr($SeqB[$SeqID+1],$r-1,2) eq “cg”) { $thermoB =
$thermoB+$dg_cg; }
                                if (substr($SeqB[$SeqID+1],$r-1,2) eq “gc”) { $thermoB =
$thermoB+$dg_gc; }
                                if (substr($SeqB[$SeqID+1],$r-1,2) eq “gg”) { $thermoB =
$thermoB+$dg_ggcc; }
                                if (substr($SeqB[$SeqID+1],$r-1,2) eq “cc”) { $thermoB =
$thermoB+$dg_ggcc; }
                        }
                        # subtract Gi
                                $thermoB = $thermoB + $Gi;
        print MYFILE “ (dG=“.substr(($thermoB),0,5).”)”;
        print MYFILE “ ”;
        # A sequence
                # Read in information for and count positive A match
                $num_matches=0;
                $matchseq = ”;
                open (FILEA, ‘tmp/’.$FILES[$p].”);
                while (<FILEA>) {
                        chomp;
                        $num_matches++;
                        ($sacc, $sstart, $send, $evalue, $positive, $mismatch, $qstart, $qend, $qseq,
$sseq, $qlen, $slen) = split(“\t”);
                                $matchseq[$num_matches] = $sseq;
                                $querseq[$num_matches] = $qseq;
                                $matchstar[$num_matches] = $qstart;
                                $matchlength[$num_matches] = $positive;
                                $mismatches[$num_matches] = $qlen − $positive;
                                $matchsacc[$num_matches] = $sacc;
                }
                close (FILEA);
                # Do thermodynamic calculations for A match
                        $q=0;
                        while ($q<$#matchseq) {
                                $q++;
                                $r=0;
                                $thermo[$q] = 0;
                                # add all pairwise matches
                                while ($r<($matchlength[$q]−1)) {
                                        $r++;
                                        # print “ ”;
                                        if (substr($matchseq[$q],$r-1,2) eq “AA”) { $thermo[$q]
= $thermo[$q]+$dg_aatt; }
                                        if (substr($matchseq[$q],$r-1,2) eq “TT”) { $thermo[$q]
= $thermo[$q]+$dg_aatt; }
                                        if (substr($matchseq[$q],$r-1,2) eq “AT”) { $thermo[$q]
= $thermo[$q]+$dg_at; }
                                        if (substr($matchseq[$q],$r-1,2) eq “TA”) { $thermo[$q]
= $thermo[$q]+$dg_ta; }
                                        if (substr($matchseq[$q],$r-1,2) eq “CA”) { $thermo[$q]
= $thermo[$q]+$dg_catg; }
                                        if (substr($matchseq[$q],$r-1,2) eq “TG”) { $thermo[$q]
= $thermo[$q]+$dg_catg; }
                                        if (substr($matchseq[$q],$r-1,2) eq “GT”) { $thermo[$q]
= $thermo[$q]+$dg_gtac; }
                                        if (substr($matchseq[$q],$r-1,2) eq “AC”) { $thermo[$q]
= $thermo[$q]+$dg_gtac; }
                                        if (substr($matchseq[$q],$r-1,2) eq “CT”) { $thermo[$q]
= $thermo[$q]+$dg_ctag; }
                                        if (substr($matchseq[$q],$r-1,2) eq “AG”) { $thermo[$q]
= $thermo[$q]+$dg_ctag; }
                                        if (substr($matchseq[$q],$r-1,2) eq “GA”) { $thermo[$q]
= $thermo[$q]+$dg_gatc; }
                                        if (substr($matchseq[$q],$r-1,2) eq “TC”) { $thermo[$q]
= $thermo[$q]+$dg_gatc; }
                                        if (substr($matchseq[$q],$r-1,2) eq “CG”) { $thermo[$q]
= $thermo[$q]+$dg_cg; }
                                        if (substr($matchseq[$q],$r-1,2) eq “GC”) { $thermo[$q]
= $thermo[$q]+$dg_gc; }
                                        if (substr($matchseq[$q],$r-1,2) eq “GG”) { $thermo[$q]
= $thermo[$q]+$dg_ggcc; }
                                        if (substr($matchseq[$q],$r-1,2) eq “CC”) { $thermo[$q]
= $thermo[$q]+$dg_ggcc; }
                                }
                                # subtract Gi
                                        $thermo[$q] = $thermo[$q] + $Gi;
                                # subtract for mispaired bases
                                        $thermo[$q] = $thermo[$q] +
$mispairpenalty*($mismatches[$num_matches]);
                        }
                # Report number of A matches
                        print MYFILE $num_matches.“ ”;
                        # Report A matches and deltaG
                        $s=0;
                        print MYFILE “\””;
                        while ($s < $num_matches) {
                                $s++;
                                print MYFILE $matchsacc[$s].“ “.$matchseq[$s].”
(dG=“.substr(($thermo[$s]),0,5).”)”;
                                if ($s < $num_matches) { print MYFILE “\n”; }
                                #print “Num: ”.$s;
                        }
                        print MYFILE “\”  ”;
        # B sequence
                # Read in information for and count positive B match
                $num_matches=0;
                $FILES[$p] =~ s/outA/outB/g;
                open (FILEB, ‘tmp/’.$FILES[$p].”);
                while (<FILEB>) {
                        chomp;
                        $num_matches++;
                        ($sacc, $sstart, $send, $evalue, $positive, $mismatch, $qstart, $pend, $qseq,
$sseq, $qlen, $slen) = split(“\t”);
                                $matchseq[$num_matches] = $sseq;
                                $querseq[$num_matches] = $qseq;
                                $matchstart[$num_matches] = $qstart;
                                $matchlength[$num_matches] = $positive;
                                $mismatches[$num_matches] = $qlen − $positive;
                                $matchsacc[$num_matches] = $sacc;
                }
                close (FILEB);
                # Do thermodynamic calculations for B match
                        $q=0;
                        while ($q<$#matchseq) {
                                $q++;
                                $r=0;
                                $thermo[$q] = 0;
                                # add all pairwise matches
                                while ($r<($matchlength[$q]−1)) {
                                        $r++;
                                        #print “ ”;
                                        if (substr($matchseq[$q],$r-1,2) eq “AA”) { $thermo[$q]
= $thermo[$q]+$dg_aatt; }
                                        if (substr($matchseq[$q],$r-1,2) eq “TT”) { $thermo[$q]
= $thermo[$q]+$dg_aatt; }
                                        if (substr($matchseq[$q],$r-1,2) eq “AT”) { $thermo[$q]
= $thermo[$q]+$dg_at; }
                                        if (substr($matchseq[$q],$r-1,2) eq “TA”) { $thermo[$q]
= $thermo[$q]+$dg_ta; }
                                        if (substr($matchseq[$q],$r-1,2) eq “CA”) { $thermo[$q]
= $thermo[$q]+$dg_catg; }
                                        if (substr($matchseq[$q],$r-1,2) eq “TG”) { $thermo[$q]
= $thermo[$q]+$dg_catg; }
                                        if (substr($matchseq[$q],$r-1,2) eq “GT”) { $thermo[$q]
= $thermo[$q]+$dg_gtac; }
                                        if (substr($matchseq[$q],$r-1,2) eq “AC”) { $thermo[$q]
= $thermo[$q]+$dg_gtac; }
                                        if (substr($matchseq[$q],$r-1,2) eq “CT”) { $thermo[$q]
= $thermo[$q]+$dg_ctag; }
                                        if (substr($matchseq[$q],$r-1,2) eq “AG”) { $thermo[$q]
= $thermo[$q]+$dg_ctag; }
                                        if (substr($matchseq[$q],$r-1,2) eq “GA”) { $thermo[$q]
= $thermo[$q]+$dg_gatc; }
                                        if (substr($matchseq[$q],$r-1,2) eq “TC”) { $thermo[$q]
= $thermo[$q]+$dg_gatc; }
                                        if (substr($matchseq[$q],$r-1,2) eq “CG”) { $thermo[$q]
= $thermo[$q]+$dg_cg; }
                                        if (substr($matchseq[$q],$r-1,2) eq “GC”) { $thermo[$q]
= $thermo[$q]+$dg_gc; }
                                        if (substr($matchseq[$q],$r-1,2) eq “GG”) { $thermo[$q]
= $thermo[$q]+$dg_ggcc; }
                                        if (substr($matchseq[$q],$r-1,2) eq “CC”) { $thermo[$q]
= $thermo[$q]+$dg_ggcc; }
                                }
                                # subtract Gi
                                        $thermo[$q] = $thermo[$q] + $Gi;
                                # subtract for mispaired bases
                                        $thermo[$q] = $thermo[$q] +
$mispairpenalty*($mismatches[$num_matches]);
                        }
                # Report number of B matches
                        print MYFILE $num_matches.“ ”;
                        # Report B matches and deltaG
                        $s=0;
                        print MYFILE “\””;
                        while ($s < $num_matches) {
                                $s++;
                                print MYFILE $matchsacc[$s].“ “.$matchseq[$s].”
(dG=“.substr(($thermo[$s]),0,5).”)”;
                                if ($s < $num_matches) { print MYFILE “\n”; }
                        }
                        print MYFILE “\”  \n”;
        close (MYFILE);
        }
exec(“EXCEL.EXE finalreport.txt”);
```

F. Summary of Example Embodiments

While there may be mistakes, shortcomings, assumptions, and choices made in the disclosure, none of these should be considered limiting and are disclosed for illustrative purposes only.

Although the above descriptions include a number of specific applications, these should not be considered limiting. Various techniques may be used in different contexts, and various contexts may benefit from different techniques and embodiments.

FIG. 9 is an embodiment of a general purpose computer 910 that may be used in connection with other embodiments of the disclosure to carry out any of the above-referenced functions. General purpose computer 910 may generally be adapted to execute any of the known OS2, UNIX, Mac-OS, Linux, Android and/or Windows Operating Systems or other operating systems. The general purpose computer 910 in this embodiment includes a processor 912, a random access memory (RAM) 914, a read only memory (ROM) 916, a mouse 918, a keyboard 920 and input/output devices such as a printer 924, disk drives 922, a display 926 and a communications link 928. In other embodiments, the general purpose computer 910 may include more, fewer, or other component parts. Embodiments of the present disclosure may include programs that may be stored in the RAM 914, the ROM 916 or the disk drives 922 and may be executed by the processor 912 in order to carry out functions described herein. The communications link 928 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 922 may include a variety of types of storage media such as, for example, floppy disk drives, hard disk drives, CD ROM drives, DVD ROM drives, magnetic tape drives or other suitable storage media. Although this embodiment employs a plurality of disk drives 922, a single disk drive 922 may be used without departing from the scope of the disclosure.

Although FIG. 9 provides one embodiment of a computer that may be utilized with other embodiments of the disclosure, such other embodiments may additionally utilize computers other than general purpose computers as well as general purpose computers without conventional operating systems. Additionally, embodiments of the disclosure may also employ multiple general purpose computers 910 or other computers networked together in a computer network. Most commonly, multiple general purpose computers 910 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 9, the logic includes computer software executable on the general purpose computer 910. The medium may include the RAM 914, the ROM 916, the disk drives 922, or other mediums. In other embodiments, the logic may be contained within hardware configuration or a combination of software and hardware configurations.

The logic may also be embedded within any other suitable medium without departing from the scope of the disclosure. Additionally, in particular embodiments, certain, some, or all of the logic may be performed automatically without human intervention.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system when executed comprising two or more of the following steps:
the collection, input, and organization of target nucleotide source or sources;
the identification of potential target sequences for ideotypically modulated pharmacoeffectors (IMP);
the exclusion, prioritization, or deprioritization of target sequences on the basis of undesirable binding for ideotypically modulated pharmacoeffectors (IMP); or
the design of targeting sequences on the basis of reverse complementarity or sequence affinity.

2. The system of claim 1, wherein said target nucleotide source(s) comprise viral, cancerous, bacterial, MHC, transplant-related, disease-causing, or of-interest cellular material.

3. The system of claim 1, wherein cancerous, autoimmune, transplant-related, or other cells are sequenced in order to provide said target nucleotide source or sources.

4. The system of claim 1, wherein cells of interest are expanded or proliferated prior to sequencing to provide said target nucleotide source or sources.

5. The system of claim 1, wherein sequences are aligned and/or sequences are compiled to a consensus sequence.

6. The system of claim 1, wherein said potential target sequences are determined using user-defined parameters and one or more search algorithm(s).

7. The system of claim 1, wherein said undesirable binding evaluation is performed using NCBI BLAST© software.

8. The system of claim 1, wherein said undesirable binding evaluation is performed using thermodynamic calculations.

9. The system of claim 1, wherein said potential target sequences are evaluated theoretically.

10. The system of claim 1, wherein said potential target sequences are evaluated physically.

11. The system of claim 1, wherein IMPs are designed with gaps of multiples of 9, 10, or 11 base pairs.

12. The system of claim 1, wherein IMPs are designed to avoid hairpin structures.

13. The system of claim 1, wherein IMPs are designed to avoid high-mutation sites.

14. The system of claim 1, wherein IMPs are designed with “wobble” sites.

15. The system of claim 1, wherein some or all functions are performed using a computer.

16. The system of claim 1, wherein some or all functions are performed by a human being.
